(19) United States
(12) Patent Application Publication
(10) Pub. No.: US 2001/0044928 A1
(43) Pub. Date: Nov. 22, 2001

(54) Method and apparatus for building a simulator

(76) Inventors: Shigeru Akaike, Okazaki-city (JP); Tatsuya Tsuge, Kuwana-gun (JP); Kengo Furuki, Chiryu-city (JP); Koji Umemura, Toyoake-city (JP)

Correspondence Address: Larry S. Nixon, Esq., NIXON & VANDERHYE P.C., 1100 North Glebe Rd., 8th Floor, Arlington, VA, 22201-4714, US

(21) Appl. No.: 09/852,260

(22) Filed: May 10, 2001

(30) Foreign Application Priority Data
May 16, 2000 (JP) 2000-143381

(51) Int. Cl. G06F 17/50

(52) U.S. Cl. 716/18

(57) ABSTRACT

The present invention allows someone not familiar with systems and programming of CAD and CAE to easily build a simulator. Process blocks divided into a sequence of work steps for simulation are previously provided using a computer system. A plurality of process blocks related will be registered and those related process blocks will be provided as predetermined process blocks. By relating those process blocks as desired, a simulator as desired may be built. Previously provided GUI components will be defined after relating blocks.

### CROSS-REFERENCE TO RELATED APPLICATION

The present invention is related to Japanese patent application No. 2000-143381, filed May 16, 2000; the contents of which are incorporated herein by reference.

### FIELD OF THE INVENTION

The present invention relates to a method and device for building a simulator, and more particularly to a method and apparatus for building a simulator for fields such as computer aided designing (CAD) and computer aided engineering (CAE).

### BACKGROUND OF THE INVENTION

To improve productivity of production management, automated systems are often used. Basically, building a knowledge base for routine work and system development for automating the work are both specialized and divided from each other. When developing an automated system, in general, order is placed on in-house system development section (or outsourcing system development).

However, when building a simulation in CAD/CAE, there are often very specialized and specific techniques even in routine work. Thus, a system engineer (SE) having ordinary skills may be required to learn and understand specialized terms and knowledge and may be unfamiliar with CAD/CAE, while a CAD/CAE engineer-user may be required to explain his/her specialized field to the SE. As a result, the productivity of building a CAD/CAE system is lower than developing, for example, an office use system in an accounting office or in a personnel section.

When adding to a system already built, users without sufficient skills are unable to personally add additions, and must ask the developer to fix and improve the system. Therefore, if an urgent and indispensable addition is added or modified, which may affect the product development, on-site improvement is not easily performed. There are also cases where building the actual system is late.

### SUMMARY OF THE INVENTION

The present invention has been made in view of the above circumstances and allows one not skilled in system development and programming in CAD or CAE to readily build a simulator of desired specifications with little effort. In a first aspect of the invention, process blocks divided into a sequence of work steps for simulation may be provided using a computer system. An operator (creator of a simulator) may define the relation between process blocks as desired. Thus, someone not skilled in or familiar with the system or programming of CAD/CAE may build a desired simulator by relating process blocks provided by the system. The present invention can also have a storage means, a display means and an input means. A plurality of already related process blocks can be stored and provided as new predetermined process blocks. In another aspect, the apparatus has a storage means, a display means and an input means as well as a registering means.

GUI components can be provided in advance. And, the GUI components can be defined after relating blocks. In another aspect, if GUI components are for regulating input data required for simulators, the regulation of input data when using the simulator will be positively performed. In particular, if components which regulate the input data required are sliding bars with upper and lower limits, the limitation of upper and lower values input when using the simulator will be positively performed.

In another aspect, after relating process blocks as desired by performing the operation test of those related blocks, the integrity can be checked to see as soon as possible after relation.

In another aspect, a block builder is provided for relating process blocks divided into a sequence of work steps for simulation. A process manager is provided for relating a sequence of work steps composed of process blocks related by the block builder to another sequence of work steps. In addition, a panel designer is provided for providing tools useful in delivering parameters with a user during simulation.

According to the above, a specialist well skilled in simulation structure may provide process blocks divided into a sequence of steps for simulation. An expert, creator of a simulator, may relate process blocks to build a simulation desired by a designer who uses the simulation. This allows a simulator to be built as desired.

As described above, in accordance with the present invention, an expert may mediate between a specialist and a designer to assist in building a simulator to allow precipitating the development of simulators.

Further areas of applicability of the present invention will become apparent from the detailed description provided hereinafter. It should be understood that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a schematic view of an apparatus for building a CAE simulator according to the invention;

FIG. 2 is a flow chart illustrating work steps in building a simulator according to the invention;

FIG. 3 is a flow chart illustrating work steps in building a simulator according to the invention;

FIG. 4A is a schematic diagram illustrating work steps in building a simulator according to the invention;

FIG. 4B is a schematic diagram illustrating work steps in building a simulator according to the invention;

FIG. 5 is a schematic diagram of a library according to the invention;

FIG. 6 is a schematic diagram of a library according to the invention;

FIG. 7 is a schematic diagram illustrating work steps in building a simulator according to the invention;

FIG. 8 is a schematic diagram illustrating work steps in building a simulator according to the invention;

FIG. 9 is a schematic diagram illustrating work steps in defining GUI components according to the invention;

FIG. 10 is a screen image display during a simulation according to the invention;

FIG. 11 is a schematic diagram illustrating a leaf spring according to the invention; and

FIG. 12 is a cross sectional view along XII-XII of FIG. 11.

### DETAILED DESCRIPTION

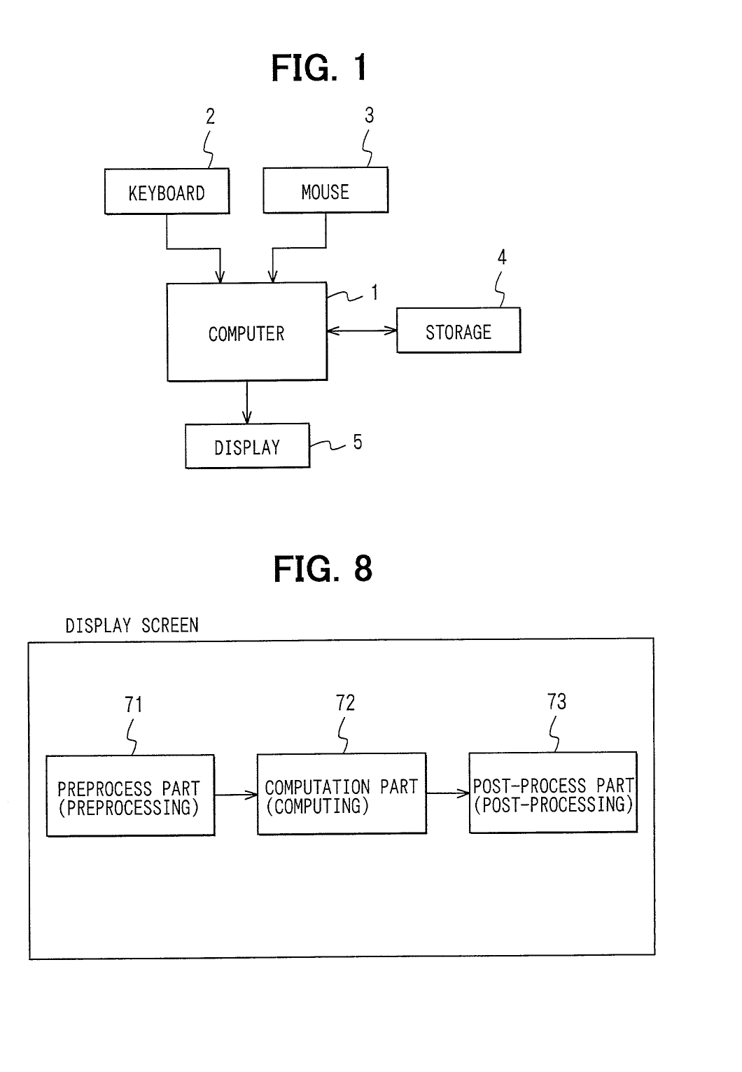

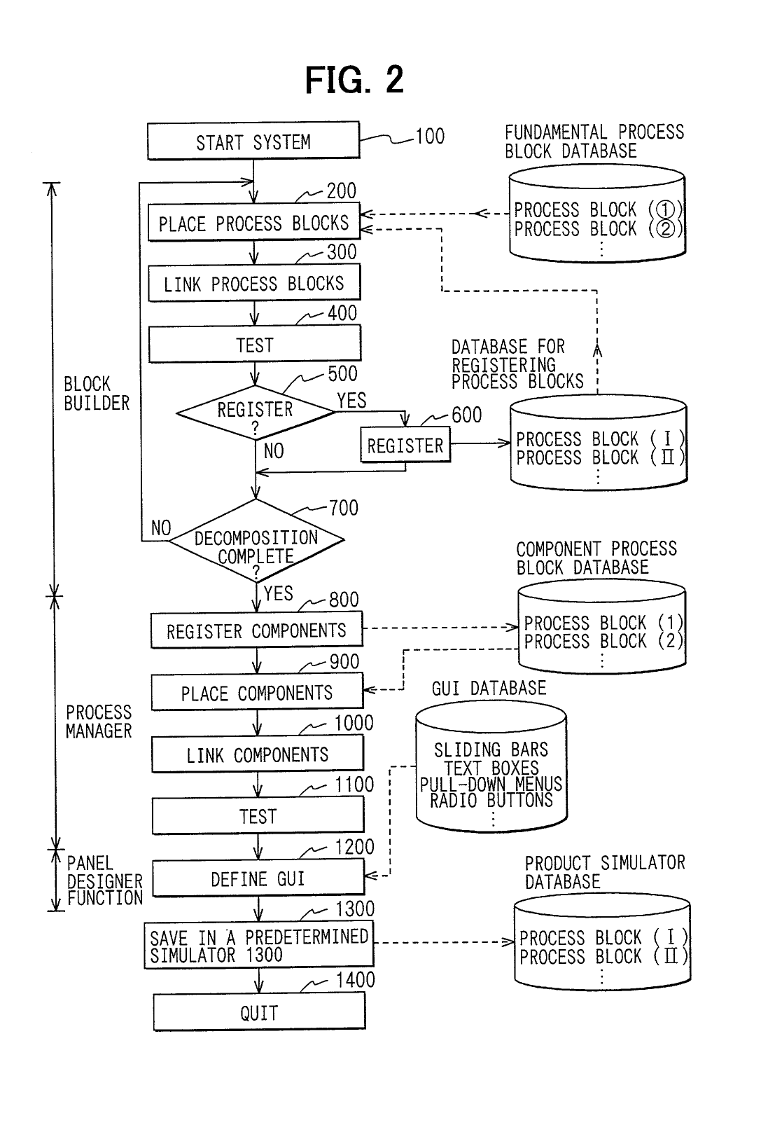

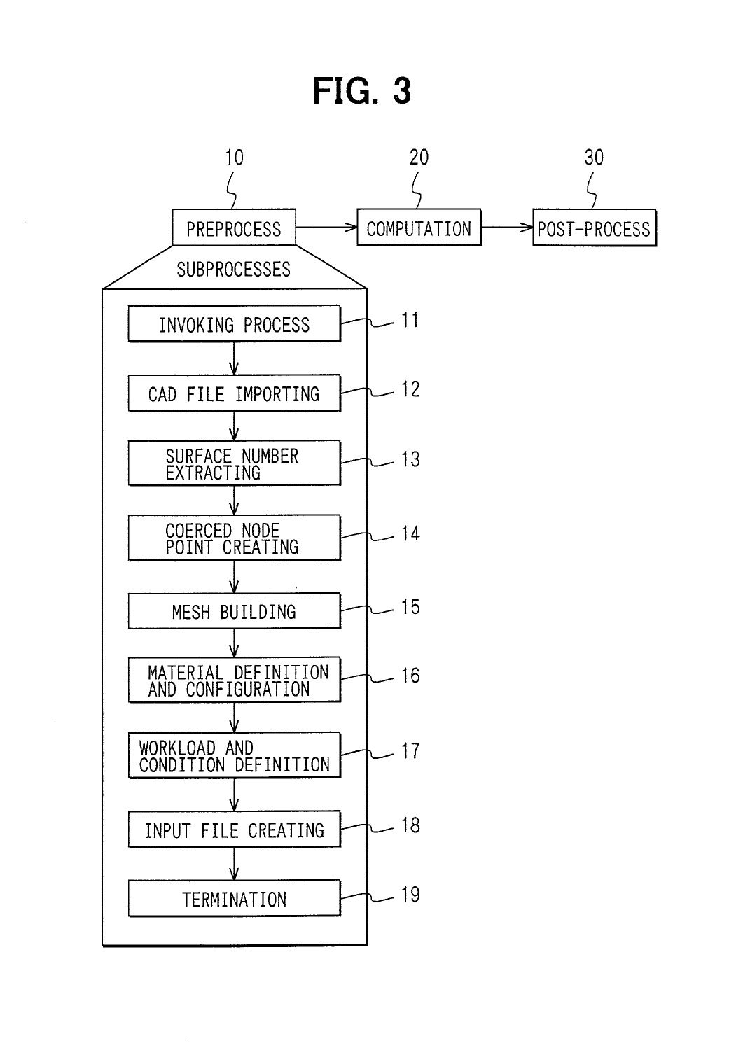

A detailed description of one preferred embodiment embodying the present invention will now be given referring to the accompanying drawings. In FIG. 1, a computer 1 is connected to a keyboard 2 and a pointing device 3 such as a mouse. The computer 1 is also connected to a storage unit 4 and a display unit 5. FIG. 2 shows a sequence of working steps for building a simulator. In the following description, an example operation of building a simulator for stress in a leaf spring will be described by way of example. For a leaf spring simulation, as shown in FIG. 3, a preprocess 10, and a computation 20 followed by a post-process 30 will be performed in order. The preprocess 10 includes an invoking process 11, a CAD file importing process 12, a surface number extracting process 13, a coerced node point creating process 14, a mesh building process 15, a material definition and configuration process 16, a workload and condition definition process 17, a input file creating process 18, and a termination process 19. The computation 20 will analyze the strength of a leaf spring by using a finite element analysis method. The post-process 30 will output and display the result.

Some basic functions specific to the apparatus for building a simulator will be now described. As shown in FIG. 2, the apparatus has (i) a block builder, (ii) a process manager, and (iii) a panel designer as fundamental functions.

The (i) block builder relates process blocks divided into a sequence of work steps for simulation. The (ii) process manager relates a sequence of work steps composed of those process blocks related by the block builder with another sequence of work steps, and may be used as a tool for linking (connecting) and placing components that are called “activities”. In other words, the block builder defines the processing logic in the “activities”, while the definition of processing logic may be achieved by placing the “process blocks” on a proprietary GUI display and connecting them by line.

The (iii) panel designer provides tools for mediating parameters with a user during simulation.

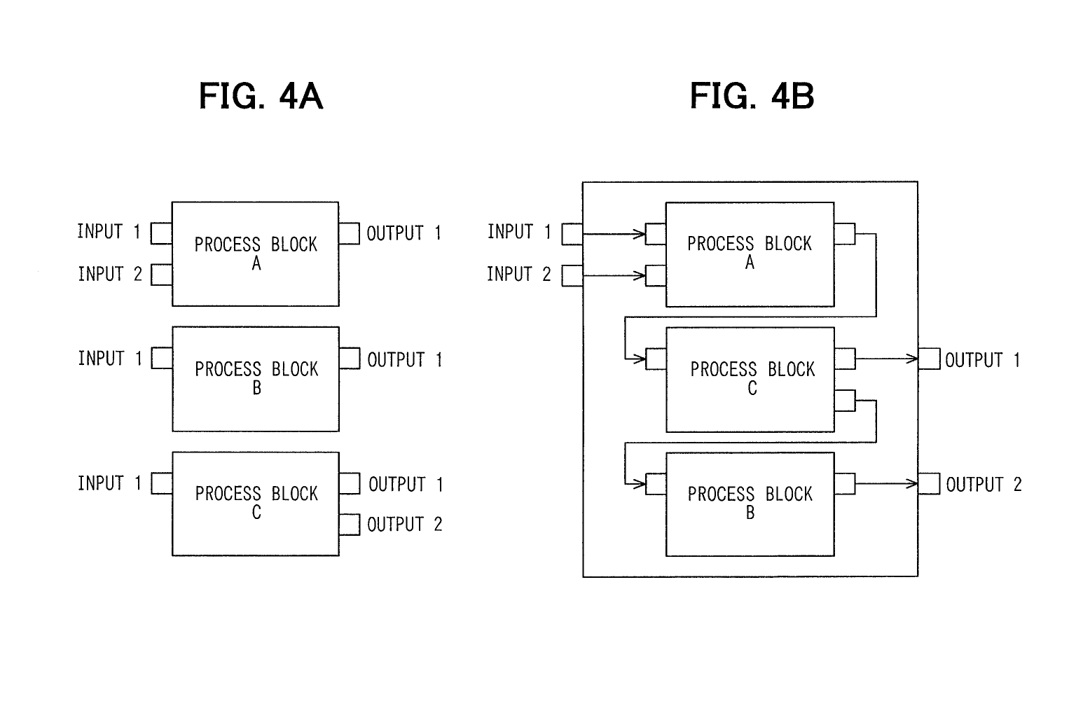

The sequence of work steps shown in FIG. 2 will be described now. In FIG. 2, the operator (creator of a simulator) starts the system (reference numeral 100 in the figure). Then the operator places process blocks (reference numeral 200). More specifically, as shown in FIG. 4A, a process block A may have two input ports and one output port, another process block B may have one input port and one output port, still another process block C may have one input port and two output port.

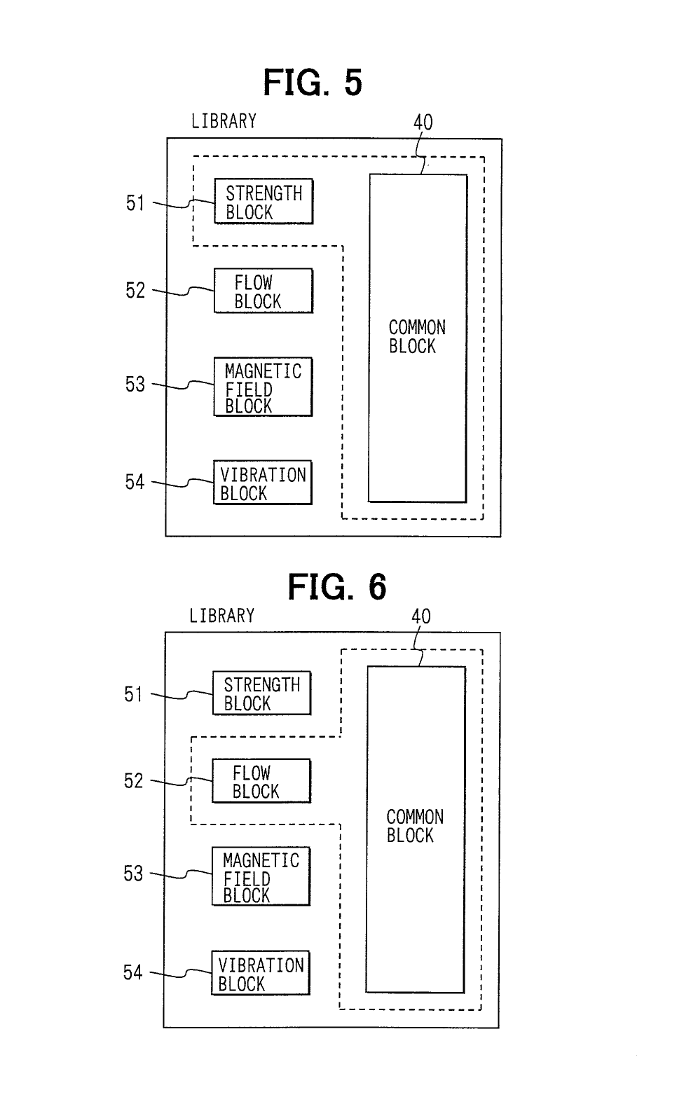

The process blocks are provided as a library as shown in FIG. 5. In FIG. 5, in addition to a block 40 commonly shared among different fields, field specific blocks 51, 52, 53, and 54 are provided. The field specific blocks 51 to 54 may be a strength block, flow block, magnetic field block, and vibration block. Then, when creating a simulator for use in the strength analysis, as shown in FIG. 5, the common block 40 is mated with the strength block 51. When creating a simulator for use in the flow analysis, as shown in FIG. 6, the common block 40 is mated with the flow block 52.

In FIG. 2, the operator will also wire process blocks (reference numeral 300). More specifically, as shown in FIG. 4B, the operator will connect the output port of the process block A to the input port of the process block C, and connect one of output port of the process block C to the input port of the process block B. The operator will define those two input ports of the process block A as the input ports of a new sequence, those output ports of process block C and process block B as the output ports of a new sequence.

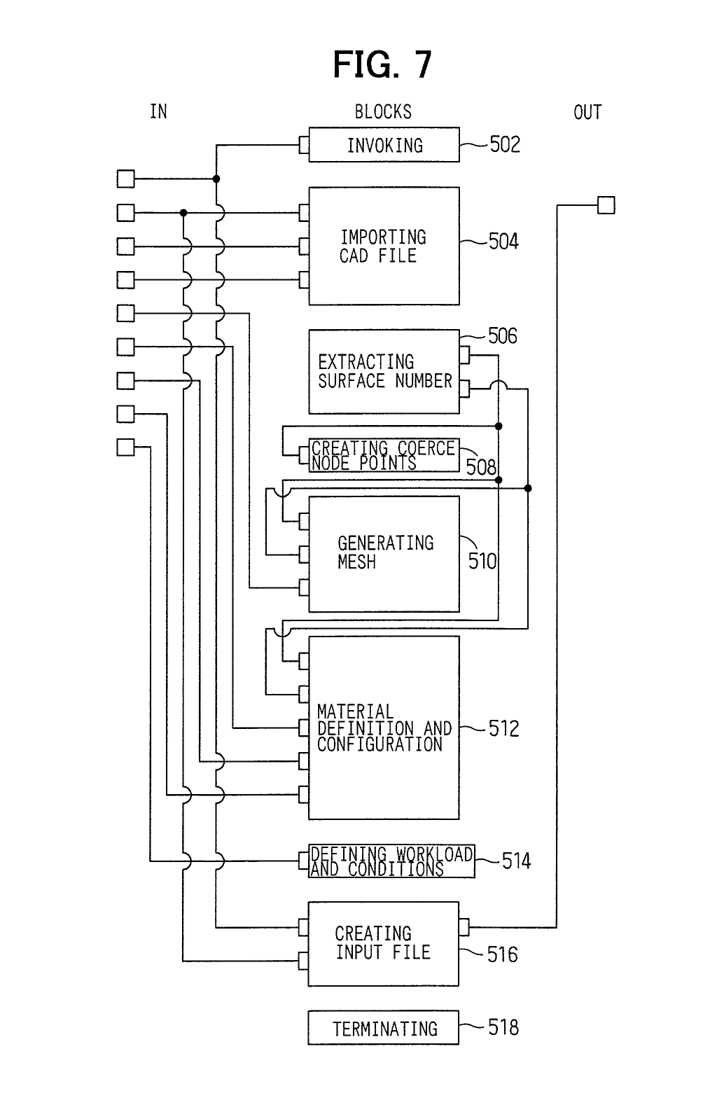

A more specific example is described by referring to FIG. 7. FIG. 7 is an example application of simulation for a leaf spring. This example has the process blocks shown in FIG. 3 as the subprocesses of the preprocess 10, including an invoking process block 502, a CAD file importing process block 504, a surface number extracting process block 506, a coerce node point generating process block 508, a mesh generating process block 510, a material definition and configuration process block 512, a workload and condition definition process block 514, an input file creation process block 516, and a termination process block 518. As shown in FIG. 7, a new sequence may have input ports and output ports determined by placing process blocks and linking them. In FIG. 7, there are nine input ports and one output port, the process sequence will proceed in the direction from the top block to the bottom block. The data at the output port of FIG. 7 will become the input data for the next activity.

As has been described above, by combining fundamental process blocks, a sophisticated process block which may perform a complex processing can be built, and by means of this methodology the process blocks indicated by the reference numeral 11 to 19 in FIG. 3 may also be built.

Next, in FIG. 2, the operator will perform the operational test of the new sequence (reference numeral 400). By performing an operational test after relating process blocks as desired, a check of new sequences can be done earlier after the relation.

Then the operator will determine whether or not the newly created sequence is to be registered (reference numeral 500). If the sequence is registered, then it will be stored in a database for the registration process block 600 (in a hard disk). During this time, registration can be done by using registration software and by pushing a registration button provided on the keyboard 2 or by using the pointing device 3. In this embodiment, the computer 1, the keyboard 2, and the pointing device 3 constitute a registering means for registering a plurality of related process blocks to provide those registered process blocks for the predetermined process blocks.

As shown by steps 500 and 600 in FIG. 2, it is convenient to register a plurality of related process blocks and provide those related process blocks as predetermined ones. More specifically, in FIG. 2, it is useful to use a database for process blocks other than the database for fundamental process blocks to register process blocks to arrange the placement of process blocks shown by reference numeral 200. As an example of usage, a specialist who knows well the structure of a simulation may provide process blocks divided into a sequence of simulated work steps. Then, an expert who is a creator of a simulator, will build a simulator desired by the designer who make use of the simulation. At this point, the expert will mediate between the specialist and the designer.

The specialist is an engineer or a class of engineers who is in charge of establishing new CAE technology, and research and development of methodologies and theories. The expert is an engineer or a class of engineers who is in charge of applying the technology developed by the specialist to the actual CAE products.

In FIG. 2, the operator determines whether one unity of process has been completed. Specifically, whether one set of a plurality of process blocks has been decomposed to fundamental pieces of process blocks or not (reference numeral 700). If completed, then the components (activities) will be registered to the database (in a hard disk) for the decomposed process blocks (reference numeral 800).

Then, the operator will place the pieces in the database for the decomposed process blocks (reference numeral 900), then links among those pieces (activities) (reference numeral 1000). More specifically, as shown in FIG. 8, a preprocess component (preprocessing activity) 71 is linked to its follower, a computation component (computing activity) 72, which will be further linked to its successor, a post-process component (post-processing activity) 73. Here, the preprocess component (preprocessing activity) 71 has been made as described above by referring to FIG. 7, and the computation component (computing activity) 72 and the post-process component (post-processing activity) 73 are the given activities of the system.

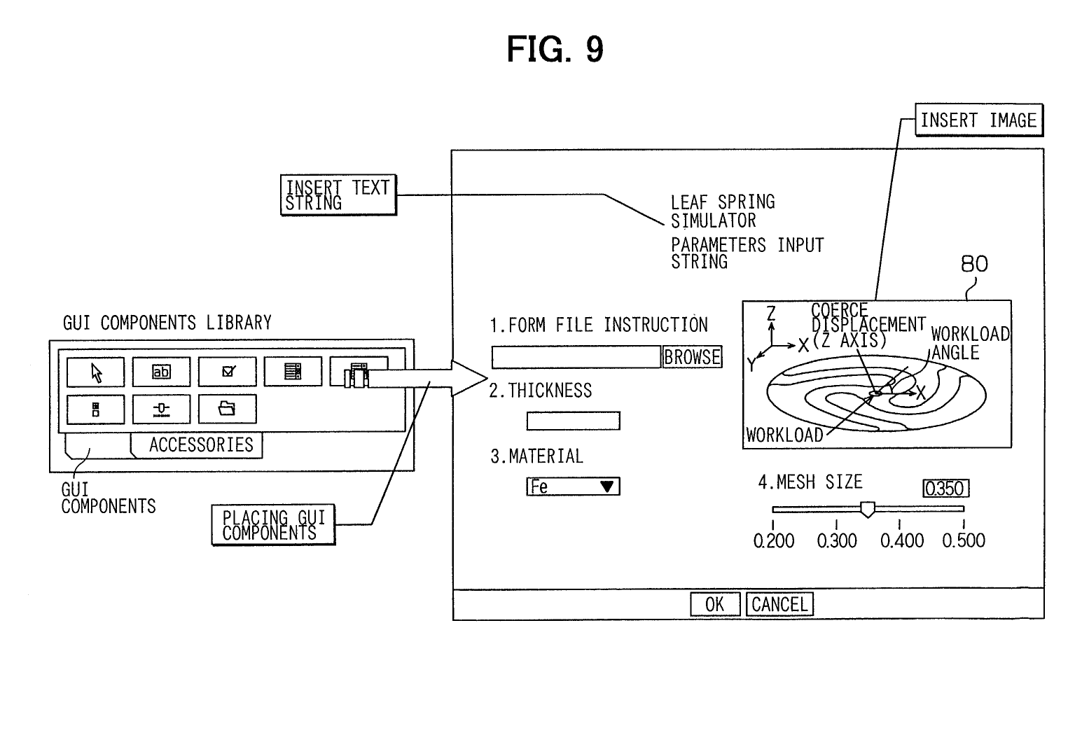

Next, in FIG. 2, the operator performs an operation test (reference numeral 1100) and thereafter defines the GUI (reference numeral 1200). More specifically, the input ports (input data) shown in FIG. 7 are defined. For example, as shown in FIG. 9, a character string (a sentence) is placed on the display by inserting a text string, or GUI components are arranged on the display from the GUI components library, or an image 80 is inserted.

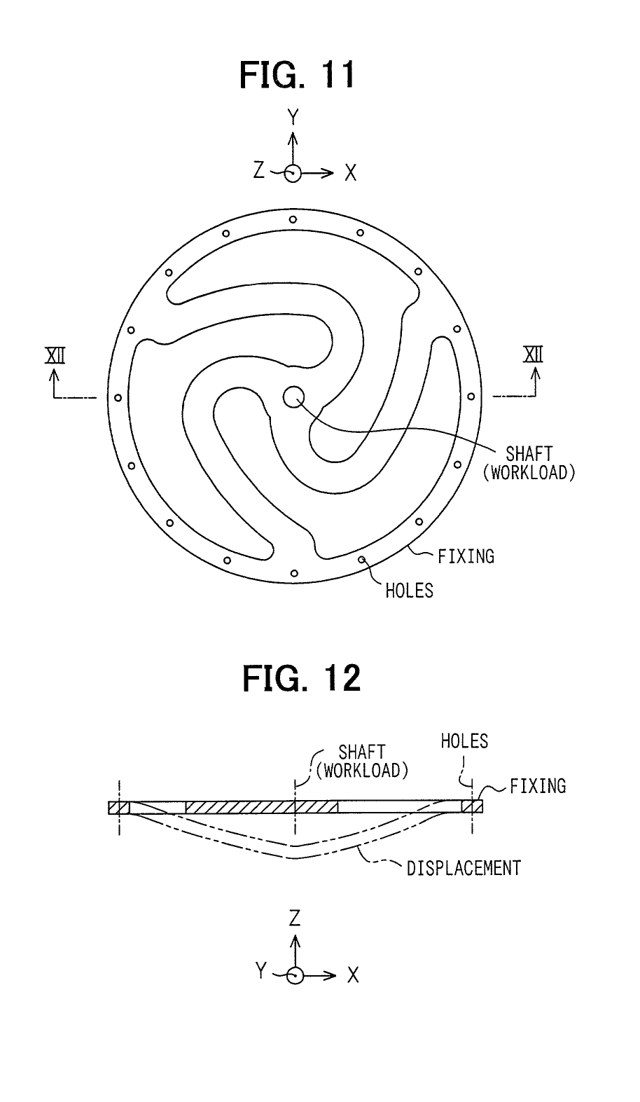

The image 80 in FIG. 9 is for navigation. The structure of the leaf spring used in this embodiment is as shown in FIG. 11 in the trigonometric expression. The leaf spring shown in FIG. 11 is expressed in the image 80 shown in FIG. 9, by a perspective view, where the perpendicular three dimensions, i.e., x-, y-, z-axis are defined. When the simulator is in use, during data input, the input values required may be configured by looking at the image 80 of FIG. 9.

As can be appreciated from the foregoing description, by implementing an image that explains the overview of a simulator by pasting an image to the “GUI display screen”, the efficiency of appointing work may be improved. That is, the designer may input values required to the request of inputting parameters while referring to an image explaining the overview of an analysis.

Thereafter, in FIG. 2, the operator saves the work into the product simulator database (in a hard disk) with an arbitrary name (reference numeral 1300). Then the operator quits the system (reference numeral 1400).

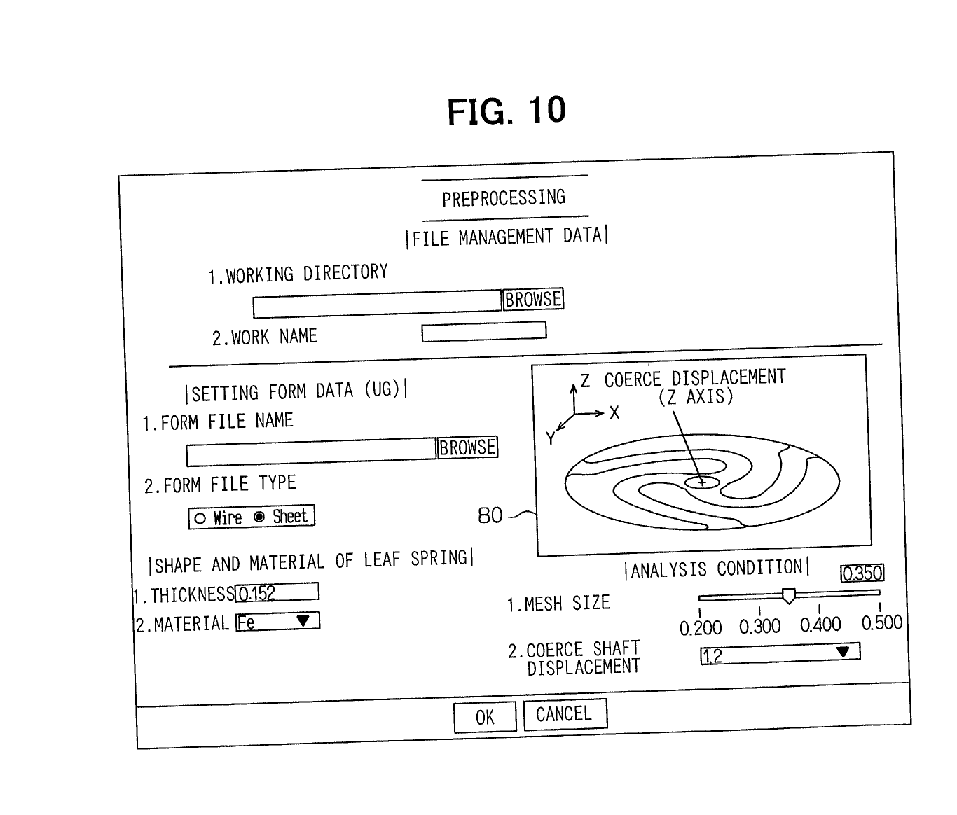

Next, the actual use of thus built simulator will be described by referring to FIG. 10. The screen image shown in FIG. 10 is a screen shot during input of required data by the designer (user of a simulator). In this display screen, there are input fields for the working directory, the work name, and the form file name. There is also an image 80 for navigation inserted in the screen. Accordingly, in a model showing a perspective view of a leaf spring, three perpendicular axis (x-, y-, z-axis) are defined and it is shown that the coerce displacement direction is in z-axis.

In FIG. 10, the form data loaded can be selected between a wire and a sheet by using a radio button. On the screen, the thickness of leaf can be specified by inputting values by using a ten-key pad for the characteristics of shape and material of the leaf spring. The name of material can be listed in a pull-down menu. When a material is selected from the pull-down menu, the Young's modulus of elasticity of that material and the Poisson's ratio will be automatically determined and inserted. For the analysis conditions, the size of mesh can be inserted by using a sliding bar. The upper and lower limits of the sliding bar are predefined in the system, to prevent a value out of this range from being entered. The coerce displacement of a shaft can be selected by using a pull-down menu. These items have been arranged in the GUI definition of FIG. 2 (reference numeral 1200 in the figure).

As can be seen from the foregoing description, some parameters, indispensably required when performing a strength analysis, such as the Young's modulus and Poisson's ratio, can be selected instead of inputting actual values by using the name of materials from a list. Therefore, the simulator is useful for someone without knowledge of the Young's modulus or Poisson's ratio. In addition, a same manner can be used for the selection of the size of mesh to be created. Furthermore, the use of a sliding bar will allow the actual data being input not to exceed the range verified by the simulator builder. As can be appreciated from the foregoing description, a simulator in accordance with the knowledge of the simulator builder or the skill level of the users can be readily built.

When input of any required parameters have been completed and the user selects the end of input (OK button), a simulation will start up. At this moment, the least minimum work direction necessary including a selection of surface of the shaft to be displaced or a selection of surface of the spring portion will be displayed on the screen. The designer will accordingly select by using the mouse. When the selection has been completed, the simulation progress will be displayed to the designer by changing the colors of icons in the screen shown in FIG. 8 (reference numerals 71, 72, and 73). More specifically, when the preprocess is completed, the icon 71 representing the preprocess will become “blue” to indicate that the preprocess has been successfully completed. While at the same time, the simulation will continue to the next computation (72) stage. In this step, the simulation is fully automatic because there is nothing to do by the designer, and the icon (activity) 72 on the screen will become “red” to indicate that the simulation is in progress.

As can be appreciated from the foregoing description, the preferred embodiment has advantages as described below.

(a) as a method for building a simulator, a desired simulator may be built by using a computer system, as shown by reference numerals 200 and 300 in FIG. 2, to split a sequence of work steps for simulation into process blocks for linking as desired. This allows someone who is not skilled in the CAE system or CAE programming to build a simulator as desired by simply linking process blocks and provided by the system.

(b) as an apparatus for building a simulator, as shown in FIG. 1, a storage device 4 is provided as a storage means for storing process blocks divided into a sequence of work steps for simulation, a display unit 5 as a display means for displaying process blocks, and a keyboard 2 or a pointing device 3 as an input means for linking process blocks displayed on the display unit 5 as desired. This apparatus allows the method (a) described above to be implemented.

(c) as a method for assisting in building a simulator, there are provided steps of providing process blocks, splitting a sequence of work steps for simulation by a specialist skilled in the structure of the simulation, and linking those process blocks by an expert who is a creator of a simulator so as to obtain a simulation desired by a designer who uses the simulation. The expert mediates between the specialist and the designer to assist in building a simulation to allow the development of simulators to be advanced far more than ever.

(d) as a method for building a simulator, as shown by reference numerals 1200 and 1300 in FIG. 2, GUI components are provided in advance, to define those GUI components after linking. The creator of a simulator is allowed to simply select some of those components, without creating a new component. More specifically, if a GUI component is the one for regulating input data required for a simulator, the regulation of input data during use of the simulator will be positively performed. In particular, if the component for regulating input data required is a sliding bar with the upper and lower limits, as shown in FIG. 10, the limitation of upper and lower values input when using the simulator can be certainly applied. In addition, the limitation of input values can be positively implemented by using a pull-down menu other than a sliding bar when inputting data.

Although in the foregoing description an embodiment of the present invention applied to CAE have been described, the present invention can be applied equivalently to CAD and the like.

While the above-described embodiments refer to examples of usage of the present invention, it is understood that the present invention may be applied to other usage, modifications and variations of the same, and is not limited to the disclosure provided herein.

What is claimed is:

1. A method of generating a simulator, comprising the steps of:
providing separate process blocks for a process sequence to be simulated;
registering a plurality of related process blocks;
providing said plurality of related process blocks as one process block; and
relating the process blocks to generate a simulator.

2. A method of generating a simulator according to claim 1, further comprising the steps of:
providing GUI components; and
defining the GUI components after the relating step.

3. A method of generating a simulator according to claim 2, wherein the GUI components are for regulating input data required by the simulator.

4. A method of generating a simulator according to claim 3, wherein the GUI components are a sliding bar having upper and lower limits.

5. A method of generating a simulator according to claims 1, wherein an operating test of related blocks is performed after relating the process blocks.

6. An apparatus for generating a simulator, comprising:
a storage means for storing process blocks divided among a sequence of working steps for simulation;
a display means for displaying the process blocks;
an input means for relating the process blocks displayed on the display means; and
a registering means for registering a plurality of related process blocks and providing those related blocks as predetermined blocks.

7. An apparatus for generating a simulator, comprising:
a block builder function for relating process blocks of a sequence of working steps for simulation;
a process manager function for relating a working step comprised of process blocks related by the block builder to another working step;
a panel designer function for providing tools for passing parameters with a user when simulating; and
a registering function for registering a plurality of related process blocks and providing those related blocks as predetermined blocks.

8. A method of assisting in building a simulator, comprising the steps of:
providing process blocks divided into a sequence of working steps for simulation by a specialist who knows well a structure of a simulation; and
relating the process blocks by an expert who creates a simulator that yields a simulation desired by a designer using the simulation.
